(19) United States
(12) Patent Application Publication
(10) Pub. No.: US 2013/0116995 A1
(43) Pub. Date: May 9, 2013

(54) AGENT-BASED ROAD TRANSPORTATION MODELING AND SIMULATION METHOD AND SYSTEM

(71) Applicant: Ming Yang, Fairport, NY (US)

(72) Inventor: Ming Yang, Fairport, NY (US)

(73) Assignee: Xerox Corporation, Norwalk, CT (US)

(21) Appl. No.: 13/292,426

(22) Filed: Nov. 9, 2011

(51) Int. Cl. G06G 7/76

(52) U.S. Cl. 703/6

(57) ABSTRACT

Methods, systems and processor-readable media for collecting vehicle data utilizing an agent-based road transportation modeling and simulation. An object can be defined to hold a vehicle and a distance can be measured along a road path from one end of a road section having a constant number of lanes and no merge and split point in the middle. A collection object can be defined to hold the defined object on a particular lane within one section of the road. A collection object can be defined to hold the above defined collection objects of one lane on a particular road section. Finally, A collection object can be defined to hold the above defined collection objects of one road section. Insert, remove and other functions can be defined to conduct a lane switch and/or other operation.

### TECHNICAL FIELD

Embodiments are generally related to ABMS (Agent-Based Modeling and Simulation). Embodiments are also related to the modeling and simulation of traffic. Embodiments are additionally related to techniques and systems for analyzing and assessing traffic congestion.

### BACKGROUND OF THE INVENTION

Road traffic control involves directing vehicular and pedestrian traffic with respect to, for example, construction zones, accidents and other road disruptions. The ability to assess and control traffic situations promotes the safety of, for example, emergency response teams, construction workers and general public. Traffic congestion is a condition on a road network that occurs as use increases, and is characterized by slower speeds, longer trip times, and increased vehicular queuing. A typical traffic simulation evaluates traffic control and predicts traffic conditions on various roads in order to effectively plan and manage a traffic control system.

Agent-based models have been employed to analyze the traffic congestion. An ABM (Agent-Based Model) is a class of computational models that simulating an action and interaction with an autonomous agent (e.g., both individual and collective entities such as organizations or groups) with a view to assess the effects on the system as a whole. An ABM combines elements of game theory, complex systems, emergence, computational sociology, multi-agent systems, and evolutionary programming. Such models can simulate simultaneous operations and interactions with respect to the multiple agents, in an attempt to re-create and predict the appearance of complex phenomena.

Conventional ABM models for controlling road traffic track autonomous interacting agent such as, for example, vehicles traveling along roads. In such a situation, the agent's next move depends on the interaction with a general continuous grid data field holding objects along x, y (and z) coordinates. Such data fields, however, are no longer sufficient to determine the agents' neighbors and are very costly and not very useful in the context of a road traffic model. Also, x, y coordinates do not provide useful information for conditions such as, for example, taking into account a slowing or speeding vehicle, a vehicle stalling or breakdown, and a vehicle's lane switch or other such movements. Additionally, converting x, y coordinates into useful road information is a slow process and prone to errors. Furthermore, operations for determining data with respect to a neighbor vehicle, are very costly and also not useful in the context of road traffic models.

Based on the foregoing, it is believed that a need exists for an improved approach to agent-based road transportation modeling and simulation, as will be described in greater detail herein.

### BRIEF SUMMARY

The following summary is provided to facilitate an understanding of some of the innovative features unique to the disclosed embodiments and is not intended to be a full description. A full appreciation of the various aspects of the embodiments disclosed herein can be gained by taking the entire specification, claims, drawings, and abstract as a whole.

It is, therefore, one aspect of the disclosed embodiments to provide for improved traffic modeling and simulation methods, systems and processor-readable media.

It is another aspect of the disclosed embodiments to provide for an improved agent-based road transportation modeling and simulation method, system and processor-readable medium.

It is a further aspect of the disclosed embodiments to provide for improved methods, systems and processor-readable medium for collecting vehicle data to determine and identify a vehicle location and a neighboring vehicle.

The aforementioned aspects and other objectives and advantages can now be achieved as described herein. A method and system for collecting vehicle data utilizing an agent-based road transportation modeling and simulation is disclosed herein. An object can be defined to maintain a vehicle and a distance can be measured along a road path from one end of a road section (e.g., composed of lines, arcs or other curves) having a constant number of lanes and no merge and split point in the middle. A collection object, referred to as collection object of one lane (e.g., array of length to be determined) can be defined to hold the above-defined objects on a particular lane within one section of the road. A collection object, referred as collection object of one road section (e.g., array of length of the lane number of a particular road section) can be defined to hold the above defined collection objects of one lane on a particular road section. Finally, a collection object, referred to as collection object of the road network (e.g., array of length of the road section number of the entire road network) can be defined to hold the above defined collection objects of one road section. An insert and remove function can be defined to conduct a lane switch and/or other operation in either the collection object of lane or any other collection objects above.

The collection object of one lane can include an array of length to be determined and preferred to be ordered by the distance from one end of a road section. A sort function can also be defined if the object data fields are not ordered/sorted. The vehicle data fields also provide information such as vehicle speeding up, vehicle braking down, vehicle following on and vehicle lane switch. The data fields to hold the vehicle objects in the agent based modeling and simulation can be employed to determine the vehicle location and a neighbor vehicle. The neighbor vehicle data can be employed to determine each agent/vehicle's next move thereby improving the simulation by order of magnitudes.

### BRIEF DESCRIPTION OF THE DRAWINGS

The accompanying figures, in which like reference numerals refer to identical or functionally-similar elements throughout the separate views and which are incorporated in and form a part of the specification, further illustrate the present invention and, together with the detailed description of the invention, serve to explain the principles of the present invention.

FIG. 1 illustrates a schematic view of a computer system, in accordance with the disclosed embodiments;

FIG. 2 illustrates a schematic view of a software system including an agent-based road transportation modeling and simulation module, an operating system, and a user interface, in accordance with the disclosed embodiments;

FIG. 3 illustrates a block diagram of an agent-based road transportation modeling and simulation system, in accordance with the disclosed embodiments;

FIG. 4 illustrates a pictorial view of a GUI offering data fields collected by the agent-based road transportation modeling and simulation system, in accordance with the disclosed embodiments; and

FIG. 5 illustrates a high level flow chart of operations illustrating logical operational steps of a method for collecting vehicle data to determine a vehicle location and a neighbor vehicle, in accordance with the disclosed embodiments.

### DETAILED DESCRIPTION

The particular values and configurations discussed in these non-limiting examples can be varied and are cited merely to illustrate at least one embodiment and are not intended to limit the scope thereof.

The embodiments now will be described more fully hereinafter with reference to the accompanying drawings, in which illustrative embodiments of the invention are shown. The embodiments disclosed herein can be embodied in many different forms and should not be construed as limited to the embodiments set forth herein; rather, these embodiments are provided so that this disclosure will be thorough and complete, and will fully convey the scope of the invention to those skilled in the art. Like numbers refer to like elements throughout. As used herein, the term “and/or” includes any and all combinations of one or more of the associated listed items.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

As will be appreciated by one of skill in the art, the present invention can be embodied as a method, data processing system, or computer program product. Accordingly, the present invention may take the form of an entirely hardware embodiment, an entirely software embodiment or an embodiment combining software and hardware aspects all generally referred to herein as a “circuit” or “module.” Furthermore, the present invention may take the form of a computer program product on a computer-usable storage medium having computer-usable program code embodied in the medium. Any suitable computer readable medium may be utilized including hard disks, USB Flash Drives, DVDs, CD-ROMs, optical storage devices, magnetic storage devices, etc.

Computer program code for carrying out operations of the present invention may be written in an object oriented programming language (e.g., Java, C++, etc.) The computer program code, however, for carrying out operations of the present invention may also be written in conventional procedural programming languages, such as the “C” programming language or in a visually oriented programming environment, such as, for example, Visual Basic.

The program code may execute entirely on the user's computer, partly on the user's computer, as a stand-alone software package, partly on the user's computer and partly on a remote computer or entirely on the remote computer. In the latter scenario, the remote computer may be connected to a user's computer through a local area network (LAN) or a wide area network (WAN), wireless data network (e.g., packet based wireless network, WiFi, Wimax, 802.xx, cellular network, etc) or the connection may be made to an external computer via most third party supported networks (for example, through the Internet using an Internet Service Provider).

The embodiments are described at least in part herein with reference to flowchart illustrations and/or block diagrams of methods, systems, and computer program products and data structures according to embodiments of the invention. It will be understood that each block of the illustrations, and combinations of blocks, can be implemented by computer program instructions. These computer program instructions may be provided to a processor of a general-purpose computer, special purpose computer, or other programmable data processing apparatus to produce a machine, such that the instructions, which execute via the processor of the computer or other programmable data processing apparatus, create means for implementing the functions/acts specified in the block or blocks.

These computer program instructions may also be stored in a computer-readable memory that can direct a computer or other programmable data processing apparatus to function in a particular manner, such that the instructions stored in the computer-readable memory produce an article of manufacture including instruction means which implement the function/act specified in the block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the functions/acts specified in the block or blocks.

These computer program instructions may also be stored in a computer-readable memory that can direct a computer or other programmable data processing apparatus to function in a particular manner, such that the instructions stored in the computer-readable memory produce an article of manufacture including instruction means which implement the function/act specified in the block or blocks.

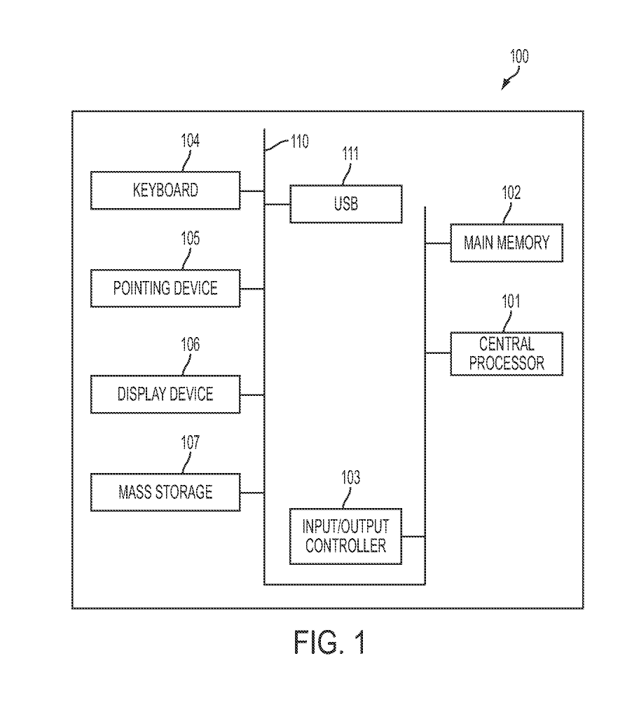

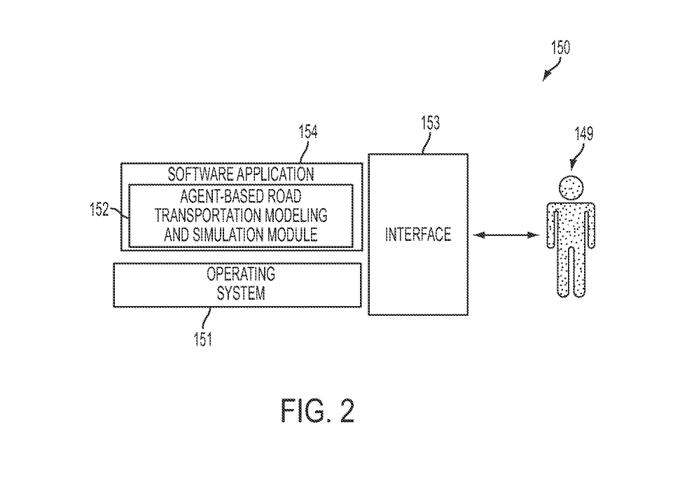

FIGS. 1-2 are provided as exemplary diagrams of data-processing environments in which embodiments of the present invention may be implemented. It should be appreciated that FIGS. 1-2 are only exemplary and are not intended to assert or imply any limitation with regard to the environments in which aspects or embodiments of the disclosed embodiments may be implemented. Many modifications to the depicted environments may be made without departing from the spirit and scope of the disclosed embodiments.

As illustrated in FIG. 1, the disclosed embodiments may be implemented in the context of a data-processing system 100 that includes, for example, a central processor 101, a main memory 102, an input/output controller 103, a keyboard 104, an input device 105 (e.g., a pointing device, such as a mouse, track ball, and pen device, etc.), a display device 106, a mass storage 107 (e.g., a hard disk), and a USB (Universal Serial Bus) peripheral connection 111. As illustrated, the various components of data-processing system 100 can communicate electronically through a system bus 110 or similar architecture. The system bus 110 may be, for example, a subsystem that transfers data between, for example, computer components within data-processing system 100 or to and from other data-processing devices, components, computers, etc.

FIG. 2 illustrates a computer software system 150 for directing the operation of the data-processing system 100 depicted in FIG. 1. Software application 154, stored in main memory 102 and on mass storage 107, generally includes a kernel or operating system 151 and a shell or interface 153. One or more application programs, such as software application 154, may be “loaded” (i.e., transferred from mass storage 107 into the main memory 102) for execution by the data-processing system 100. The data-processing system 100 receives user commands and data through user interface 153; these inputs may then be acted upon by the data-processing system 100 in accordance with instructions from operating system module 152 and/or software application 154.

The following discussion is intended to provide a brief, general description of suitable computing environments in which the system and method may be implemented. Although not required, the disclosed embodiments will be described in the general context of computer-executable instructions, such as program modules, being executed by a single computer. In most instances, a “module” constitutes a software application.

Generally, program modules include, but are not limited to routines, subroutines, software applications, programs, objects, components, data structures, etc., that perform particular tasks or implement particular abstract data types and instructions. Moreover, those skilled in the art will appreciate that the disclosed method and system may be practiced with other computer system configurations, such as, for example, hand-held devices, multi-processor systems, data networks, microprocessor-based or programmable consumer electronics, networked PCs, minicomputers, mainframe computers, servers, and the like.

Note that the term module as utilized herein may refer to a collection of routines and data structures that perform a particular task or implements a particular abstract data type. Modules may be composed of two parts: an interface, which lists the constants, data types, variable, and routines that can be accessed by other modules or routines, and an implementation, which is typically private (accessible only to that module) and which includes source code that actually implements the routines in the module. The term module may also simply refer to an application, such as a computer program designed to assist in the performance of a specific task, such as word processing, accounting, inventory management, etc.

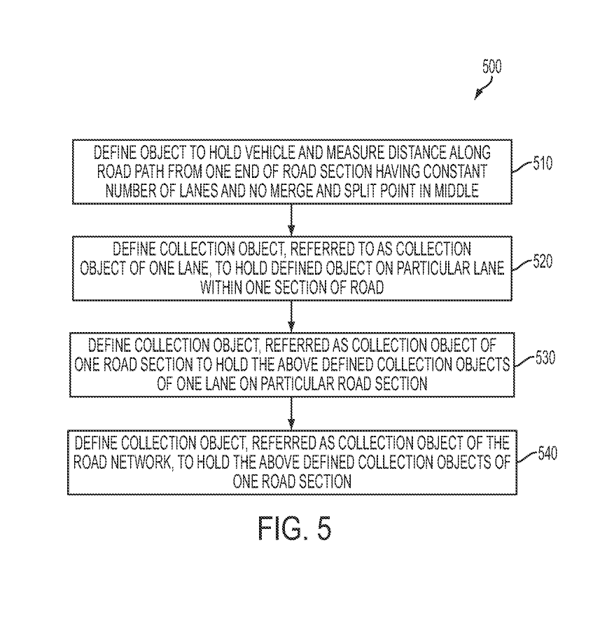

The interface 153, which is preferably a graphical user interface (GUI), also serves to display results, whereupon the user may supply additional inputs or terminate the session. In an embodiment, operating system 151 and interface 153 can be implemented in the context of a “Windows” system. It can be appreciated, of course, that other types of systems are potential. For example, rather than a traditional “Windows” system, other operation systems, such as, for example, Linux may also be employed with respect to operating system 151 and interface 153. The software application 154 can include an agent-based road transportation modeling and simulation module 152 for collecting vehicle data. Software application 154, on the other hand, can include instructions, such as the various operations described herein with respect to the various components and modules described herein, such as, for example, the method 500 depicted in FIG. 5.

FIGS. 1-2 are thus intended as examples, and not as architectural limitations of disclosed embodiments. Additionally, such embodiments are not limited to any particular application or computing or data-processing environment. Instead, those skilled in the art will appreciate that the disclosed approach may be advantageously applied to a variety of systems and application software. Moreover, the disclosed embodiments can be embodied on a variety of different computing platforms, including Macintosh, UNIX, LINUX, and the like.

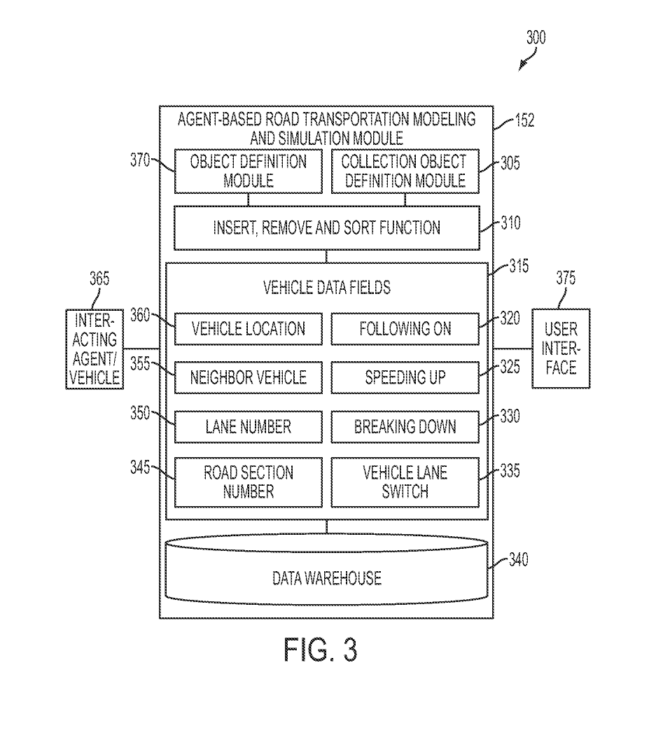

FIG. 3 illustrates a block diagram of an agent-based road transportation modeling and simulation system 300, in accordance with the disclosed embodiments. Note that in FIGS. 1-5 identical parts or elements are generally indicated by identical reference numerals. The system 300 can be employed to model, forecast, and analyze the movement of a vehicle 365. The system 300 can be configured to include the agent-based road transportation modeling and simulation module 152 for collecting vehicle data fields 310. In general, agent-based modeling is an approach based on an idea that a system is composed of decentralized individual ‘agents’ and that each agent interacts with other agents according to localized knowledge. Agents are intelligent individuals who make decisions based upon the interactions with other agents and the environment in which they are situated. The agent-based modeling is developed by identifying the agent types and other objects (classes) along with their attributes. Note that the agent can be for example, vehicles traveling along roads.

The agent-based road transportation modeling and simulation module 152 further includes an object definition module 370, a collection object definition module 305, and an insert, remove and sort function 310 and a data warehouse 340. The complete set of object class definitions and methods, parameter values, and initial values for the entire agent 365 and other object states constitutes a complete specification of an agent model. The system 300 is simulated by capturing the behavior of the individual agent 365 and their interconnections. The agent-based road transportation modeling and simulation module 152 can be employed to test how changes in individual behaviors affect the system's 300 emerging overall behavior.

The object definition module 370 defines an object to hold the vehicle/interacting agent 365 and to measure a road path from one end of a road section having a constant number of lanes and no merge and split point in the middle. Note the road section may include lines, arcs or other curves, depending upon design consideration. The collection object definition module 305 defines a collection object to hold the defined object on a particular lane within one section of the road. The collection object may be for example, array of length to be determined preferred to be ordered by the distance.

An insert, remove function and sort function 310 can be defined to conduct a lane switch and other operation by defining a collection object to hold the defined lane collections on a particular road section. The sort function 310 can be employed to sort the vehicle data 315 if the vehicle data 315 is not sorted. The collection object can be for example, an array of length of the lane number of a particular road section. Finally, the data fields 315 with respect to the vehicle 365 on the roads can be defined to hold the defined road section collections. The collection object includes array of length to be determined and preferred to be ordered by the distance.

The data fields 315 with respect to the vehicle 365 includes array of length of the number of the road sections in the analyzed road network. The data field 315 also provides information such as vehicle following on 320, vehicle speeding up 325, vehicle braking down 330, and vehicle's lane switch 335. The vehicle data fields 315 can be stored in the data warehouse 340. Note that the data warehouse 340 may include multiple databases, depending upon design consideration. The agent-based road transportation modeling and simulation module 152 utilizes the simulation data fields 315 stored in the data warehouse 340 to create a traffic pattern and the stored simulation data fields 315 may be displayed on a user interface 375.

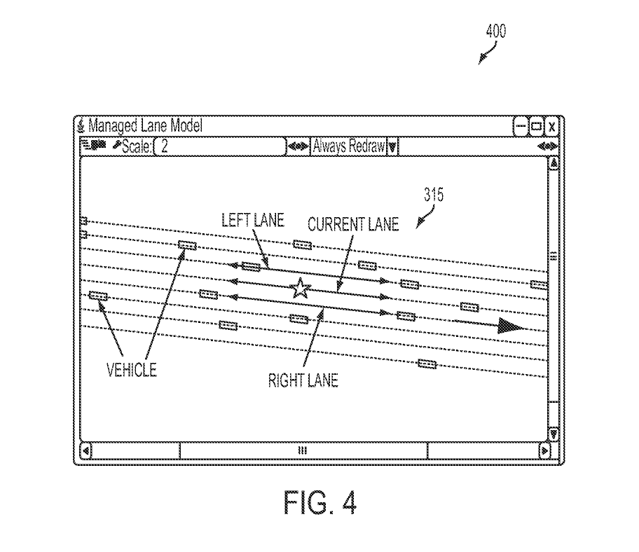

FIG. 4 illustrates a pictorial view of a GUI 400 offering data fields 315 collected by the agent-based road transportation modeling and simulation system 300, in accordance with the disclosed embodiments. The GUI 400 can be implemented via a GUI such as, for example, the GUI 153 depicted in FIG. 2 herein, and may be provided by a module, such as, for example, module 152 (e.g., a software application) shown in FIG. 1. Additionally, it can be appreciated that GUI 400 can be displayed via a display device such as display 106 depicted in FIG. 1. In the illustrated figures herein, the GUI 400 can be generally implemented in the context of a GUI “window”.

Note that in computing, a GUI “window” is generally a visual area containing some type of user interface. Such a “window” usually (but not always) possesses a rectangular shape, and displays the output of and may allow input to one or more processes. Such windows are primarily associated with graphical displays, where it can be manipulated with a mouse cursor, such as, for example, the input device 105 depicted in FIG. 1. The GUI 400 thus can display the data fields 315 to hold the vehicle object and can be employed to determine the vehicle/agent's lane number 350, the road section number 345, the vehicle location 360 and the neighbor vehicle 355.

FIG. 5 illustrates a high level flow chart of operations illustrating logical operational steps of a method 500 for collecting vehicle data to find a vehicle location and a neighbor vehicle, in accordance with the disclosed embodiments. It can be appreciated that the logical operational steps shown in FIG. 5 can be implemented or provided via, for example, a module such as module 152 shown in FIG. 2. Initially, the object can be defined to hold the vehicle 365 and the distance can be measured along a road path from one end of a road section (consisting of lines, arcs or other curves) having a constant number of lanes and no merge and split point in the middle, as indicated at block 510. The collection object, which can be referred to as a collection object of one lane, can be defined or designated to hold the defined object on a particular lane within one section of the road, as shown at block 520.

Thereafter, as illustrated at block 530, the collection object, which can be referred as a collection object of one road section (e.g., array of length of the lane number of a particular road section) can be defined or designated to hold the above defined collection objects of one lane on a particular road section. Finally, the collection object, which can be referred to as a collection object of the road network (e.g., array of length of the road section number of the entire road network) can be defined or designated to hold the above defined collection objects of one road section, as depicted at block 540. An insert and remove function can be further defined to conduct a lane switch and/or other operations in either the collection object of lane as indicated at block 520 or any other collection objects above, as indicated at blocks 530 or 540. The data field 315 to hold the vehicle objects in the agent based modeling and simulation can be employed to determine a vehicle/agent's lane number 350, the road section number 345, a vehicle location 360 and a neighbor vehicle 355. The neighbor vehicle 355 can be employed to determine each agent/vehicle 365 next move thereby improving the simulation by order of magnitudes.

Based on the foregoing, it can be appreciated that a number of embodiments, preferred or alternative, are disclosed herein. For example, in one embodiment, an agent-based road transportation modeling and simulation method is described. Such an embodiment can include, for example, defining an object to maintain a representation of a simulation of a vehicle and thereafter measure a distance along a simulated road path from one end of a simulated road section thereof having a plurality of lanes without a merge and a split point in a middle of the simulated road section; defining a lane collection object to hold the defined object on a particular lane of the plurality of lanes within the simulated road section, a road section collection object to maintain the lane collection object on a particular simulated road section, and a road network collection object to maintain the road section collection on a particular simulated road network; and defining insert, remove and other functions to conduct a lane switch and/or other operation and therefore analyze and assess traffic congestion and conditions with respect to the simulated road section.

In another embodiment, an operation can be provided for configuring the lane collection object to include an array of length to be determined and/or preferred to be ordered by the distance. In yet another embodiment, an operation can be provided for configuring the road section collection object to include an array of lane collection objects of length of lane number on the particular road section. In still another embodiment, an operation can be provided for configuring the road network collection object to include an array of road section collection objects of length of road section number on the simulated road network.

In another embodiment, an operation can be provided for defining a sort function if the plurality of data fields with respect to the simulation of the vehicle is not sorted. In other embodiments, an operation can be provided for configuring the plurality of data fields to include one or more of, for example, the following types of data: data indicative of an increase in speed of the vehicle, data indicative of a slowing in speed of the vehicle, data indicative of a breakdown of the vehicle, data indicative of a following of the vehicle, data indicative of a lane switch by the vehicle, etc. In still other embodiments, an operation can be provided for determining data indicative of a location of the vehicle and a location of a neighbor vehicle with respect to the vehicle utilizing data contained in the plurality of data fields, in order to maintain the vehicle object in the agent based modeling and simulation. In still other embodiments, an operation can be provided for determining data indicative of a next move of the vehicle by the neighbor vehicle.

In still other embodiments, an agent-based road transportation modeling and simulation system can be implemented. Such a system can include, for example, a processor, and a data bus coupled to the processor. Such a system can further include a computer-usable medium embodying computer code, the computer-usable medium being coupled to the data bus. The computer program code can include instructions executable by the processor and configured for defining an object to maintain a representation of a simulation of a vehicle and thereafter measure a distance along a simulated road path from one end of a simulated road section thereof having a plurality of lanes without a merge and a split point in a middle of the simulated road section; defining a lane collection object to hold the defined object on a particular lane of the plurality of lanes within the simulated road section, a road section collection object to maintain the lane collection object on a particular simulated road section, and a road network collection object to maintain the road section collection on a particular simulated road network; and defining insert, remove and other functions to conduct a lane switch and/or other operation and therefore analyze and assess traffic congestion and conditions with respect to the simulated road section.

In other system embodiments, the aforementioned lane collection object can be configured to include an array of length to be determined and/or preferred to be ordered by the distance. In yet other system embodiments, the road section collection object can be configured to include an array of lane collection objects of length of lane number on the particular road section. In still other system embodiments, the road network collection object can be configured to include an array of road section collection objects of length of road section number on the simulated road network. In other system embodiments, the aforementioned instructions can be further configured for defining a sort function if the plurality of data fields with respect to the simulation of the vehicle is not sorted.

In other system embodiments, the aforementioned plurality of data fields can be configured to include one or more of, for example, the following types of data: data indicative of an increase in speed of the vehicle, data indicative of a slowing in speed of the vehicle, data indicative of a breakdown of the vehicle, data indicative of a following on of the vehicle, data indicative of a lane switch by the vehicle, etc. In yet other system embodiments, such instructions can be further configured for determining data indicative of a location of the vehicle and a location of a neighbor vehicle with respect to the vehicle utilizing data contained in the plurality of data fields, in order to maintain the vehicle object in the agent based modeling and simulation. In other embodiments, such instructions can be configured for determining data indicative of a next move of the vehicle by the neighbor vehicle.

In still other embodiments, a processor-readable medium storing code representing instructions to cause a process to perform a process for agent-based road transportation modeling and simulation can be provided. Such code can comprise code to, for example, define an object to maintain a representation of a simulation of a vehicle and thereafter measure a distance along a simulated road path from one end of a simulated road section thereof having a plurality of lanes without a merge and a split point in a middle of the simulated road section, define a lane collection object to hold the defined object on a particular lane of the plurality of lanes within the simulated road section, a road section collection object to maintain the lane collection object on a particular simulated road section, and a road network collection object to maintain the road section collection on a particular simulated road network, and define insert, remove and other functions to conduct a lane switch and/or other operation and therefore analyze and assess traffic congestion and conditions with respect to the simulated road section.

In other embodiments of such a processor-readable medium, the code can comprise code to, for example, configure the lane collection object to include an array of length to be determined and/or preferred to be ordered by the distance. In yet other embodiments of such a processor-readable medium, the code can comprise code to, for example, configure the road section collection object to include an array of lane collection objects of length of lane number on the particular road section. In still other embodiments of such a processor-readable medium, the code can comprise code to, for example, configure the road network collection object to include an array of road section collection objects of length of road section number on the simulated road network.

It will be appreciated that variations of the above-disclosed and other features and functions, or alternatives thereof, may be desirably combined into many other different systems or applications. Also that various presently unforeseen or unanticipated alternatives, modifications, variations or improvements therein may be subsequently made by those skilled in the art which are also intended to be encompassed by the following claims.

1. An agent-based road transportation modeling and simulation method, said method comprising:
defining an object to maintain a representation of a simulation of a vehicle and thereafter measure a distance along a simulated road path from one end of a simulated road section thereof having a plurality of lanes without a merge and a split point in a middle of said simulated road section;
defining a lane collection object to hold said defined object on a particular lane of said plurality of lanes within said simulated road section, a road section collection object to maintain said lane collection object on a particular simulated road section, and a road network collection object to maintain said road section collection on a particular simulated road network; and
defining insert, remove and other functions to conduct a lane switch and/or other operation and therefore analyze and assess traffic congestion and conditions with respect to said simulated road section.

2. The method of claim 1 further comprising configuring said lane collection object to include an array of length to be determined and/or preferred to be ordered by said distance.

3. The method of claim 1 further comprising configuring said road section collection object to include an array of lane collection objects of length of lane number on said particular road section.

4. The method of claim 1 further comprising configuring said road network collection object to include an array of road section collection objects of length of road section number on said simulated road network.

5. The method of claim 1 further comprising defining a sort function if said plurality of data fields with respect to said simulation of said vehicle is not sorted.

6. The method of claim 1 further comprising configuring said plurality of data fields to include provide at least one of the following types of data:
data indicative of an increase in speed of said vehicle;
data indicative of a slowing in speed of said vehicle;
data indicative of a breakdown of said vehicle;
data indicative of a following on of said vehicle; and
data indicative of a lane switch by said vehicle.

7. The method of claim 1 further comprising determining data indicative of a location of said vehicle and a location of a neighbor vehicle with respect to said vehicle utilizing data contained in said plurality of data fields, in order to maintain said vehicle object in said agent based modeling and simulation.

8. The method of claim 5 further comprising determining data indicative of a next move of said vehicle by said neighbor vehicle.

9. An agent-based road transportation modeling and simulation system, said system comprising:
a processor;
a data bus coupled to said processor; and
a computer-usable medium embodying computer code, said computer-usable medium being coupled to said data bus, said computer program code comprising instructions executable by said processor and configured for:
defining an object to maintain a representation of a simulation of a vehicle and thereafter measure a distance along a simulated road path from one end of a simulated road section thereof having a plurality of lanes without a merge and a split point in a middle of said simulated road section;
defining a lane collection object to hold said defined object on a particular lane of said plurality of lanes within said simulated road section, a road section collection object to maintain said lane collection object on a particular simulated road section, and a road network collection object to maintain said road section collection on a particular simulated road network; and defining insert, remove and other functions to conduct a lane switch and/or other operation and therefore analyze and assess traffic congestion and conditions with respect to said simulated road section.

10. The system of claim 9 wherein said lane collection object is configured to include an array of length to be determined and/or preferred to be ordered by said distance.

11. The system of claim 9 wherein said road section collection object is configured to include an array of lane collection objects of length of lane number on said particular road section.

12. The system of claim 9 wherein said road network collection object is configured to include an array of road section collection objects of length of road section number on said simulated road network.

13. The system of claim 9 further comprising wherein said instructions are further configured for defining a sort function if said plurality of data fields with respect to said simulation of said vehicle is not sorted.

14. The system of claim 9 further wherein said plurality of data fields is configured to include provide at least one of the following types of data:
data indicative of an increase in speed of said vehicle;
data indicative of a slowing in speed of said vehicle;
data indicative of a breakdown of said vehicle;
data indicative of a following on of said vehicle; and
data indicative of a lane switch by said vehicle.

15. The system of claim 9 wherein said instructions are further configured for determining data indicative of a location of said vehicle and a location of a neighbor vehicle with respect to said vehicle utilizing data contained in said plurality of data fields, in order to maintain said vehicle object in said agent based modeling and simulation.

16. The system of claim 13 wherein said instructions are further configured for determining data indicative of a next move of said vehicle by said neighbor vehicle.

17. A processor-readable medium storing code representing instructions to cause a process to perform a process for agent-based road transportation modeling and simulation, said code comprising code to:
define an object to maintain a representation of a simulation of a vehicle and thereafter measure a distance along a simulated road path from one end of a simulated road section thereof having a plurality of lanes without a merge and a split point in a middle of said simulated road section;
define a lane collection object to hold said defined object on a particular lane of said plurality of lanes within said simulated road section, a road section collection object to maintain said lane collection object on a particular simulated road section, and a road network collection object to maintain said road section collection on a particular simulated road network; and
define insert, remove and other functions to conduct a lane switch and/or other operation and therefore analyze and assess traffic congestion and conditions with respect to said simulated road section.

18. The processor-readable medium of claim 17 wherein said code further comprises code to configure said lane collection object to include an array of length to be determined and/or preferred to be ordered by said distance.

19. The processor-readable medium of claim 17 wherein said code further comprises code to configure said road section collection object to include an array of lane collection objects of length of lane number on said particular road section.

20. The processor-readable medium of claim 17 wherein said code further comprises code to configure said road network collection object to include an array of road section collection objects of length of road section number on said simulated road network.
